(19) United States
(12) Patent Application Publication
(10) Pub. No.: US 2025/0375887 A1
(43) Pub. Date: Dec. 11, 2025

(54) AUTONOMOUS ENERGY TRANSFER SYSTEM

(71) Applicant: Caterpillar Inc., Peoria, IL (US)

(72) Inventors: Jeffery M. OTHMAN, Naperville, IL (US); Mathew FLEMMER, Christchurch (NZ); Rodrigo ESPINOZA, Jindalee (AU); Matthew SHERWOOD, Christchurch (NZ)

(73) Assignee: Caterpillar Inc., Peoria, IL (US)

(21) Appl. No.: 18/736,148

(22) Filed: Jun. 6, 2024

(51) Int. Cl. B25J 9/16; B25J 11/00; B60L 53/16; B60L 53/18; E05F 15/00; H02G 11/00

(52) U.S. Cl. CPC B25J 9/1697; B25J 11/008; B60L 53/16; B60L 53/18; E05F 15/00; B60L 2200/40; E05Y 2900/518; E05Y 2900/534; H02G 11/00

(57) ABSTRACT

An autonomous energy transfer system includes a robotic system that includes an end effector; a slide system for moving the robotic system; a cable management system for managing energy transfer cables; an energy transfer outlet system for the energy transfer cables; a first camera system for obtaining image data associated with a receptacle access point of a work machine; a second camera system for obtaining image data associated with an access mechanism of the receptacle access point and one or more receptacles included in the receptacle access point; a door opening system for opening an access door of the receptacle access point; a door closing system for closing the access door; a connector retention system for enabling coupling between one or more plugs of the end effector and the one or more receptacles; and a connector protection system for protecting the one or more plugs.

### TECHNICAL FIELD

The present disclosure relates generally to an energy transfer system and, for example, to an autonomous energy transfer system.

### BACKGROUND

Machines (e.g., that utilizes another type of energy source other than fossil fuel, such as electricity, hydrogen, methanol, ammonia, or other sources of energy other than a fossil fuel), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. However, in many cases, when a machine operates throughout the day, the on-board energy storage system needs to be replenished several times over the course of the day (e.g., at least five (5) times per day) to ensure that the machine has enough power to continuously operate. In some cases, a technician can connect one or more energy replenishing connectors to one or more receptacles of the machine (e.g., that are associated with an on-board energy storage system of the machine) to allow for the on-board energy storage system of the machine to be replenished. However, this manual process is subject to error (e.g., where a connector is not accurately inserted into a receptacle). This can result in a sub-optimal replenishment of the on-board energy storage system for the machine, such as in terms of an increased amount of time needed to replenish the energy for the machine and a decreased available energy level on-board the machine. Sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and/or an operable life of the on-board energy storage system, and of the machine.

China Patent No. CN111071088 (“the '088 patent”) discloses an electric vehicle automatic charging device with an intelligent identification function and a capability of automatically opening and closing a charging door and inserting and removing a charging gun. Per the '088 patent, a charging robot is mainly composed of a multi-axis manipulator, a charging door and charging port intelligent identification system, a charging door opening and closing mechanism, a charging port measuring assembly, a cable follow-up control mechanism, a control system and the like. Further detailed in the '088 patent, the charging port measuring component is mainly composed of a camera, a visual sensor or a laser radar, and is used to measure a spatial position of a charging door and a charging port on an electric vehicle. Additionally, the '088 patent discusses that the cable following control mechanism comprises a cable flexible joint, a cable traction mechanism, a cable tensioning mechanism and a cable flexible following mechanism.

Moreover, the '088 patent describes a process where the charging port intelligent identification mechanism is started to identify a charging door on a side wall of an electric vehicle and accurately measure the three-dimensional spatial position of the charging door, and to transmit the data to the intelligent identification system. The multi-axis manipulator is started, and a load plug connector carried by a manipulator head is inserted into a plug slot on a switch measuring component in a robot hanging box, and the plug slot is then securely plugged in by mechanical locking or electromagnetic suction. The multi-axis manipulator carries a switch charging door mechanism and a charging port measuring component to extend, and operates the switch charging door mechanism to open the charging door. At the same time, the charging port measuring component scans the charging door on the charging port and feeds the data back to the control system. The control system processes the data to obtain the three-dimensional spatial position of the charging door on a charging port. The control system controls the multi-axis manipulator to continue to operate the switch charging door mechanism to open the charging door on the charging port of the charging gun. The charging port measurement component scans the charging port and feeds the data back to the control system, the control system processes the data to obtain the three-dimensional spatial position of the charging port, and then the multi-axis manipulator carries the switch charging door mechanism and the charging port measurement component back, and puts the switch charging door mechanism and the charging port measurement component back into the robot hanging box. Further, the multi-axis manipulator inserts the load plug connector carried by the manipulator head into a charging gun assembly in the robot hanging box and carries the charging gun assembly out to accurately insert the charging gun assembly into the charging port. Then the multi-axis manipulator retracts, inserts another charging gun into another charging port, and then retracts back to the box to wait.

Additionally, per the '088 patent, after charging is completed, the multi-axis manipulator is started, and two charging gun assemblies are unplugged and plugged back into the hanging box one by one through the load plug connector carried on the manipulator head, and finally the charging door switch mechanism is carried and operated again to close the charging door of the charging port and the charging door on the electric vehicle.

While the '088 patent discloses an electric vehicle automatic charging device, the '088 patent does not disclose providing any means to protect the electric vehicle automatic charging device (e.g., from environmental conditions) when not in use (e.g., when not charging an electric vehicle). This renders the electric vehicle automatic charging device impractical for particular real-world applications, such as for charging electric machines that operate at a work site associated with an industry, such as mining or construction, with harsh environmental conditions.

The autonomous energy transfer system of the present disclosure solves one or more of the problems set forth above and/or other problems in the art.

### SUMMARY

An autonomous energy transfer system may include a robotic system that includes an end effector; a housing that includes a portal at an end of the housing; a slide system for moving the robotic system, via the portal of the housing, between an interior of the housing and an external environment; a cable management system mounted within the interior of the housing for providing management of energy transfer cables; an energy transfer outlet system mounted within the interior of the housing for enabling connection between the energy transfer cables and an external energy transfer dispenser system; a first camera system mounted on an exterior of the housing for obtaining first image data associated with a receptacle access point of a work machine; a second camera system mounted on the end effector of the robotic system for obtaining second image data associated with an access mechanism of the receptacle access point and third image data associated with one or more receptacles included in the receptacle access point; a door opening system mounted on the end effector of the robotic system for opening an access door of the receptacle access point; a door closing system mounted on the end effector of the robotic system for closing the access door of the receptacle access point; a connector retention system mounted on the end effector of the robotic system for enabling coupling between one or more plugs of the end effector and the one or more receptacles; and a connector protection system mounted on the end effector of the robotic system for protecting the one or more plugs when the one or more plugs are not coupled to the one or more receptacles.

An end effector of a robotic system may include a camera system for obtaining first image data associated with an access mechanism of a receptacle access point of a work machine and second image data associated with one or more receptacles included in the receptacle access point; a door opening system for opening an access door of the receptacle access point; a door closing system for closing the access door of the receptacle access point; a connector retention system for enabling coupling between one or more plugs of the end effector and the one or more receptacles; and a connector protection system for protecting the one or more plugs when the one or more plugs are not coupled to the one or more receptacles.

A method, may include causing, by a controller of an autonomous energy transfer system, a first camera system to obtain first image data associated with a receptacle access point of a work machine; identifying, by the controller and based on the first image data, that the receptacle access point of the work machine is within an engagement range of a robotic system of the autonomous energy transfer system; causing, by the controller, a second camera system to obtain second image data associated with an access mechanism of the receptacle access point; identifying, by the controller and based on the second image data, a first location of the access mechanism of the receptacle access point; causing, by the controller and based on the identifying first location, a door opening system to open an access door of the receptacle access point; causing, by controller, the second camera system to obtain third image data associated with one or more receptacles included in the receptacle access point; identifying, by the controller and based on the third image data, a second location of the one or more receptacles; and causing, by the controller and based on identifying the second location, one or more plugs of an end effector of the robotic system to couple to the one or more receptacles to enable an energy transfer to the work machine.

### BRIEF DESCRIPTION OF THE DRAWINGS

FIG. 1 is a diagram of an example work machine described herein.

FIGS. 2A-2B are diagrams of examples of a receptacle access point described herein.

FIGS. 3A-3B are diagrams of an example autonomous energy transfer system described herein.

FIGS. 4A-4B are diagrams of examples of an end effector of a robotic system of the autonomous energy transfer system described herein.

FIG. 5 is a diagram of example components of a device associated with an autonomous energy transfer system.

FIG. 6 is a flowchart of an example process associated with an autonomous energy transfer system.

### DETAILED DESCRIPTION

This disclosure relates to an autonomous energy transfer system that is configured to enable an energy transfer to a work machine, which is applicable to any work machine that is at least partially powered by a non-fossil-fuel-based energy storage system. The work machine may be any type of machine configured to perform operations associated with an industry such as mining, construction, farming, transportation, or any other industry.

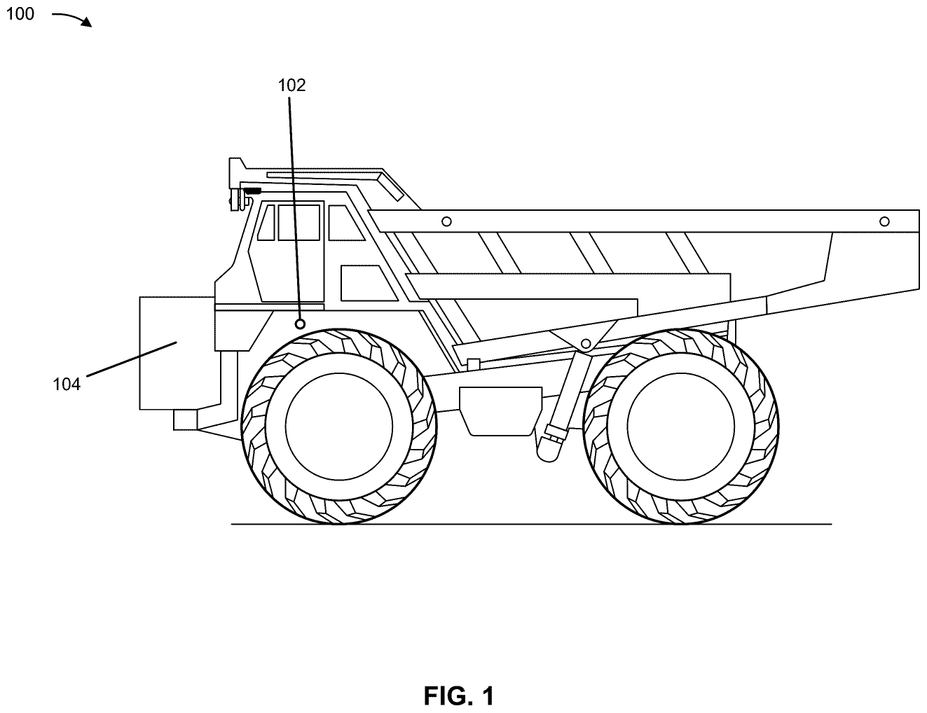

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine may be a machine that utilizes electricity, hydrogen, methanol, ammonia, or other sources of energy other than a fossil fuel. As a specific example, when the energy storage system 102 includes a battery that stores electricity, the work machine 100 may be a battery electric machine (BEM), a battery electric vehicle (BEV), a hybrid vehicle, a fuel cell and battery hybrid vehicle, or another machine that is at least partially powered by the battery of the energy storage system 102. The work machine 100 may include one or more engines, one or more motors, one or more conversion systems, and/or other components that are configured to convert and/or use energy stored in the energy storage system 102, to cause overall movement of the work machine 100 across a work site and/or to cause movement of individual components or systems of the work machine 100.

When the energy storage system 102 stores electricity, the energy storage system 102 may include one or more batteries, such as one or more lithium-ion (Li-ion) batteries, lithium-ion polymer batteries, nickel-metal hydride (NiMH) batteries, lead-acid batteries, nickel cadmium (Ni—Cd) batteries, zinc-air batteries, sodium-nickel chloride batteries, or other types of batteries. In some implementations, multiple battery cells may be grouped together, in series or in parallel, within a battery module. Multiple battery modules may be grouped together, such as in series, within a battery string. One or more battery strings may be provided within a battery pack, such as a group of battery strings linked together in parallel. Accordingly, the energy storage system 102 may include one or more battery packs, one or more battery strings, one or more battery modules, and/or one or more battery cells.

When the energy storage system 102 stores hydrogen, the energy storage system 102 may include one or more hydrogen fuel cells. A hydrogen fuel cell may store hydrogen in compressed gas form or in a liquid state. When the energy storage system 102 stores methanol, ammonia, or another type of alternative fuel (e.g., other than a fossil fuel, electricity, or hydrogen), the energy storage system 102 may include one or more chemical storage components, which may include tanks, containers, other types of chemical storage components.

The receptacle access point 104 provides an energy transfer interface (e.g., a physical energy transfer interface) for the energy storage system 102. For example, the receptacle access point 104 provides an energy transfer interface that can be physically connected to an energy transfer system (e.g., the autonomous energy transfer system 300 described herein) to allow an energy transfer from the energy transfer system to the energy storage system 102 (or vice versa). The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

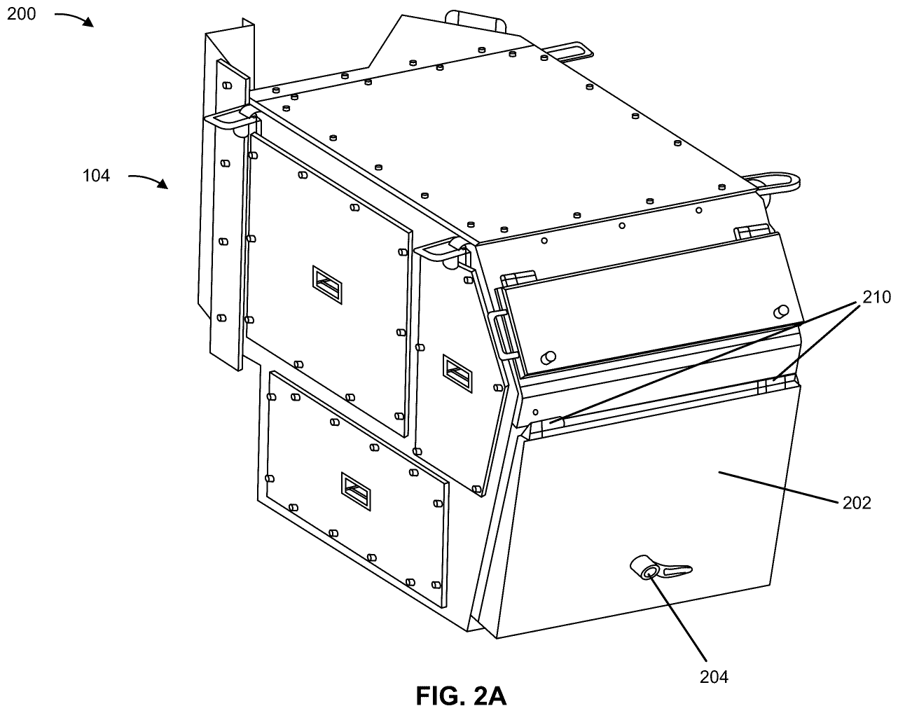

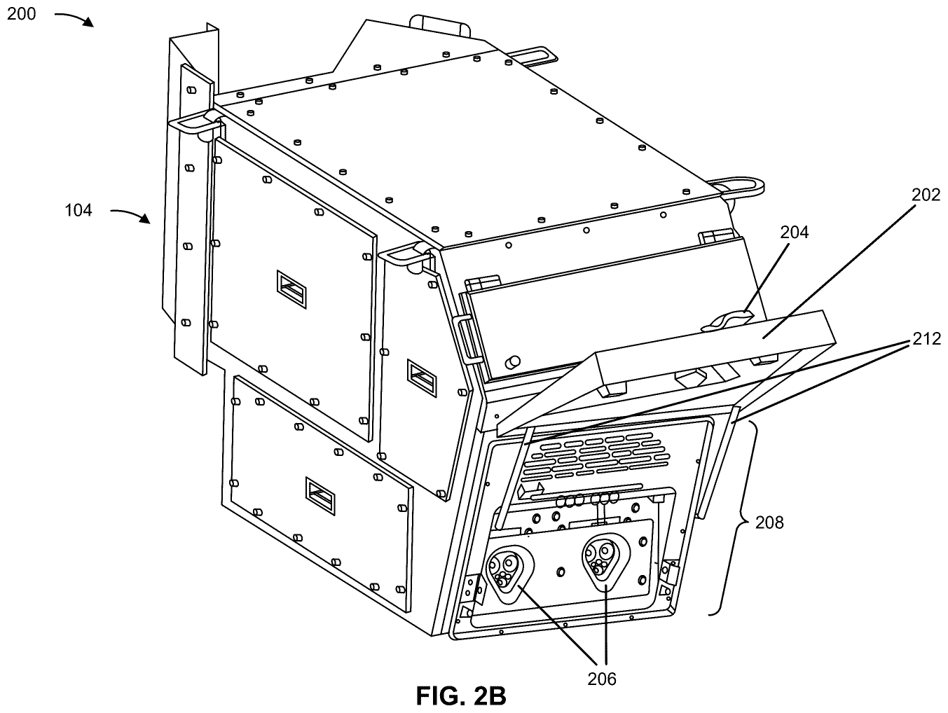

FIGS. 2A-2B are diagrams (e.g., front-angled views) of examples 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

The access door 202 comprises a metal, or other hard and/or weather resistant material, and is configured to protect internal components of the receptacle access point 104, such as an interior panel 208 of the receptacle access point 104, when in the closed position. For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access door 202 is moveable. For example, the access door 202 may be moved from the closed position (e.g., shown in FIG. 2A) to the open position (e.g., shown in FIG. 2B), such as by causing the access door 202 to pivot on one or more hinges 210. The receptacle access point 104 may include one or more support components 212 (e.g., one or more stays, one or more pistons, and/or one or more pneumatic cylinders, among other examples) that facilitate opening of the access door 202 (e.g., that facilitate movement of the access door 202 from the closed position to the open position) and/or that facilitate the access door 202 remaining in the open position (e.g., by resisting any force exerted on the access door 202 that is less than a force threshold that is associated with closing the access door 202, as further described herein).

The access mechanism 204 may be located on the access door 202, as shown in FIGS. 2A-2B, or may be located at any other position on the receptacle access point 104. The access mechanism 204 is configured to allow the access door 202 to open (e.g., to allow the access door 202 to move from the closed position to the open position and/or to remain at the open position) when the access mechanism 204 is disengaged. Further, the access mechanism 204 is configured to allow the access door 202 to remain closed (e.g., to remain in the closed position) when the access mechanism is engaged (e.g., after the access door 202 is moved to the closed position). That is, the access mechanism 204 may “lock” the access door 202 in the closed position when engaged, and may “unlock” the access door 202 to allow the access door 202 to move to the open position when disengaged.

The access mechanism 204 is configured to be manipulatable to cause the access mechanism 204 to be engaged (e.g., to change from disengaged to engaged) or to be disengaged (e.g., to change from engaged to disengaged). For example, the access mechanism 204 may be configured to be rotated, slid, pushed, pulled, lifted, extended, and/or retracted, among other examples, to cause the access mechanism 204 to be engaged or disengaged. Accordingly, the access mechanism 204 may include a latch, a bolt, a catch, a hook, a hasp, and/or a fastener, among other examples. The access mechanism 204 may include a portion, such as a latch portion, upon which a force can be applied to cause the access mechanism 204 to disengage (or, alternatively, to engage).

As shown in FIG. 2B, the one or more receptacles 206 may be included on the interior panel 208 of the receptacle access point 104. Each of the one or more receptacles 206 may be any type of physical component for coupling with a plug of an energy transfer system (e.g., a plug 402 of the autonomous energy transfer system 300 described herein) to enable an energy transfer from the energy transfer device to the energy storage system 102 (or vice versa). While the term “receptacles” are used herein, the one or more receptacles 206 may include plugs, ports, connectors, or any other type of physical energy transfer component.

As indicated above, FIGS. 2A-2B are provided as an example. Other examples may differ from what is described in connection with FIGS. 2A-2B.

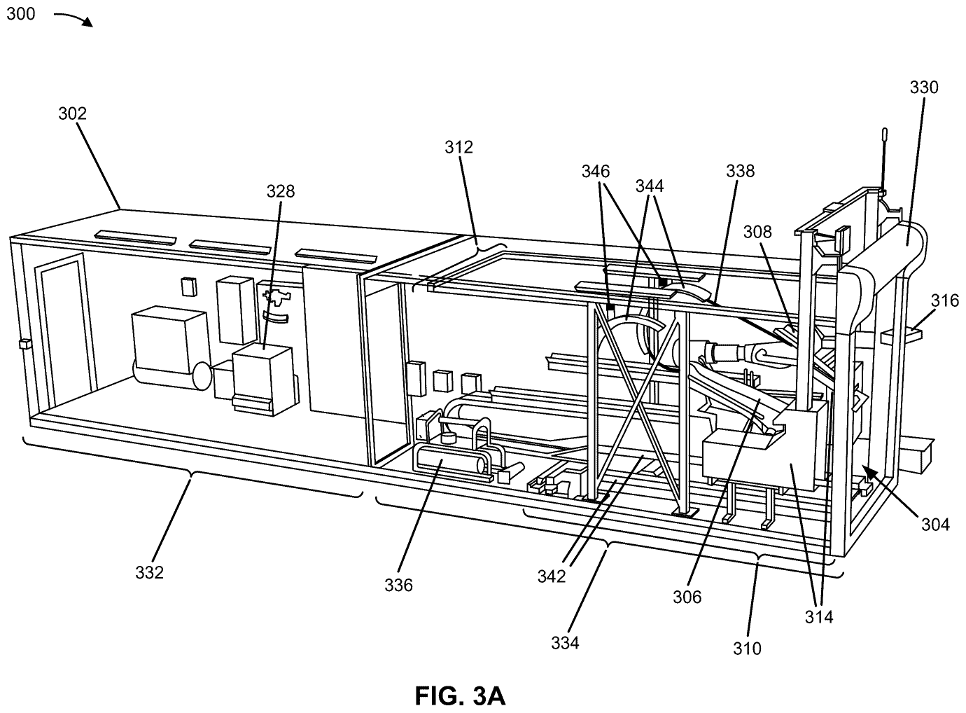

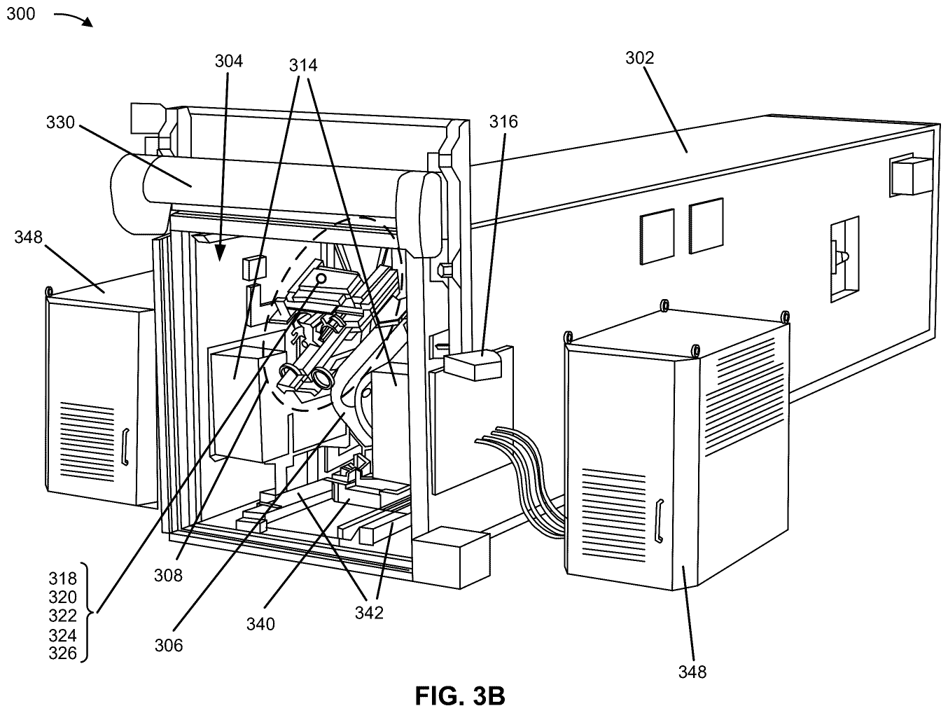

FIGS. 3A-3B are diagrams of an example autonomous energy transfer system 300. The autonomous energy transfer system 300 is configured to enable an energy transfer to and/or from the work machine 100 (e.g., to and/or from the energy storage system 102 of the work machine 100). In some implementations, the autonomous energy transfer system 300 is configured to autonomously enable the energy transfer (e.g., as further described herein), such as without any interaction with a human technician. However, other implementations include a human technician interacting with the autonomous energy transfer system 300 and, thus, the term “autonomous energy transfer system” includes any energy transfer system that is at least semi-autonomous (e.g., includes at least one autonomously controlled or operated system or component). FIG. 3A shows a side (cut-away) view of the autonomous energy transfer system 300, and FIG. 3B shows a front-angled view of the autonomous energy transfer system 300.

As shown in FIGS. 3A-3B, the autonomous energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 comprises a metal, or other hard and/or weather resistant material, and may have a rectangular prism shape. For example, the housing 302, may have a similar size and/or dimensions of a shipping container (e.g., with four “long” sides and two “short” sides). The housing 302 may include the portal 304 at an end of the housing 302 (e.g., instead of one of the short sides of the housing 302). The autonomous energy transfer system 300 may include an access door 330 that is configured to cover the portal 304 when closed, and to uncover the portal 304 when open. For example, the access door 330 may be a retractable door. The access door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302. The first interior portion 332 of the housing 302 may be accessible (e.g., via another access door of the housing 302) to allow a human technician to enter and monitor and/or perform maintenance on the one or more controllers 328 and/or other components of the first interior portion 332, without being proximate to the systems and components included in the second interior portion 334 of the housing 302. This enhances safety of the autonomous energy transfer system 300, such as by minimizing a risk of accident or injury associated with being exposed to operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein). As shown in FIG. 3A, the second interior portion 334 may be associated with the end of the housing 302 that includes the portal 304. Accordingly, as shown in FIG. 3A, the slide system 310, the cable management system 312, and the energy transfer outlet system 314 may be mounted within the interior of the housing 302 (e.g., within the second interior portion 334 of the housing 302) such that the slide system 310, the cable management system 312, and the energy transfer outlet system 314 are positioned within a region of the interior of the housing 302 that is associated with the end of the housing 302 (e.g., to allow the slide system 310, the cable management system 312, and the energy transfer outlet system 314 to be proximate to the portal 304).

The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The slide system 310 may include a mount 340 for connecting to the robotic system 306 (e.g., for holding the robotic system 306 as the robotic system is moved by the slide system 310) and a slide apparatus 342 for moving the robotic system 306. For example, when the access door 330 is open, the slide apparatus 342 may be configured to slide the robotic system 306 from the second interior portion 334 of the housing 302 to the external environment (e.g., to allow the robotic system 306 have uninhibited movement to enable an energy transfer operation) and to slide the robotic system 306 from the external environment to the second interior portion 334 (e.g., to allow the robotic system 306, when not enabling an energy transfer operation, to be protected from environmental conditions associated with the external environment). The slide apparatus 342 may also provide management of cables or other components associated with operation of the robotic system 306 (e.g., that supply power, pressurized air, pressurized water, among other examples to the robotic system 306). For example, the slide apparatus may include one or more structural components to prevent the cables or other components from being damaged when the slide apparatus moves the robotic system 306.

The cable management system 312 is configured to provide management of the one or more energy transfer cables 338. For example, as shown in FIG. 3A, the cable management system 312 may include one or more cable holder components 344 that prevent bending of the one or more energy transfer cables 338 (e.g., beyond a bend radius of the one or more energy transfer cables 338). Additionally, the cable management system 312 may include one or more slide apparatuses 346 that are configured to move the one or more cable holder components 344. For example, the one or more slide apparatuses 346 may move the one or more cable holder components 344 in association with (e.g., in tandem with) with movement of the robotic system 306 by the slide system 310 (e.g., to prevent a likelihood of damage to the one or more energy transfer cables 338 due to movement of the robotic system 306).

The energy transfer outlet system 314 is configured for enabling connection between the one or more energy transfer cables 338 and an external transfer dispenser system 348 (e.g., that is not included in the autonomous energy transfer system 300). The external transfer dispenser system 348 may be, for example, configured as a high-capacity external transfer dispenser system that transmits and distributes electrical power at a scale of millions of watts (megawatts). Accordingly, the external transfer dispenser system 348 may provide energy to the one or more energy transfer cables 338, and thus to plugs of the end effector (e.g., the plugs 402 described herein) via the energy transfer outlet system 314.

The energy transfer outlet system 314, by being positioned within the interior of the housing 302 (e.g., within the second interior portion 334 of the housing 302), allows a length of the one or more energy transfer cables 338 to be reduced (e.g., as compared to energy transfer cables that would need to be externally routed to the external transfer dispenser system 348), which further mitigates a likelihood of damage to the one or more energy transfer cables 338 (e.g., due to bending, tangling, kinking, or other issues). Further, the energy transfer outlet system 314, by being a separate system that is not integrated into the external transfer dispenser system 348, allows the external transfer dispenser system 348 to remain external to the autonomous energy transfer system 300. This enables the positioning and operation of the other systems and components of the autonomous energy transfer system 300 as described herein.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100). For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation.

As shown in FIG. 3A, the second interior portion 334 of the housing 302 may include the robotic system 306 (e.g., mounted to the mount 340 of the slide system 310), such as when the robotic system 306 been moved to the interior of the housing 302 by the slide system 310. The robotic system 306 is configured to enable an energy transfer to or from the work machine 100 (e.g., to or from the energy storage system 102 of the work machine 100), such as when the robotic system 306 been moved to the external environment by the slide system 310.

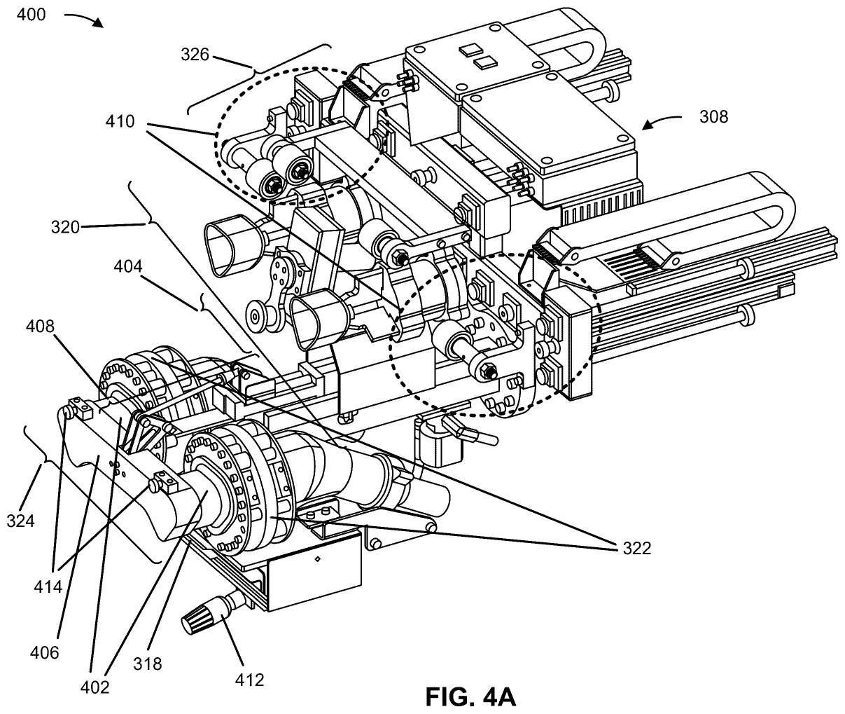

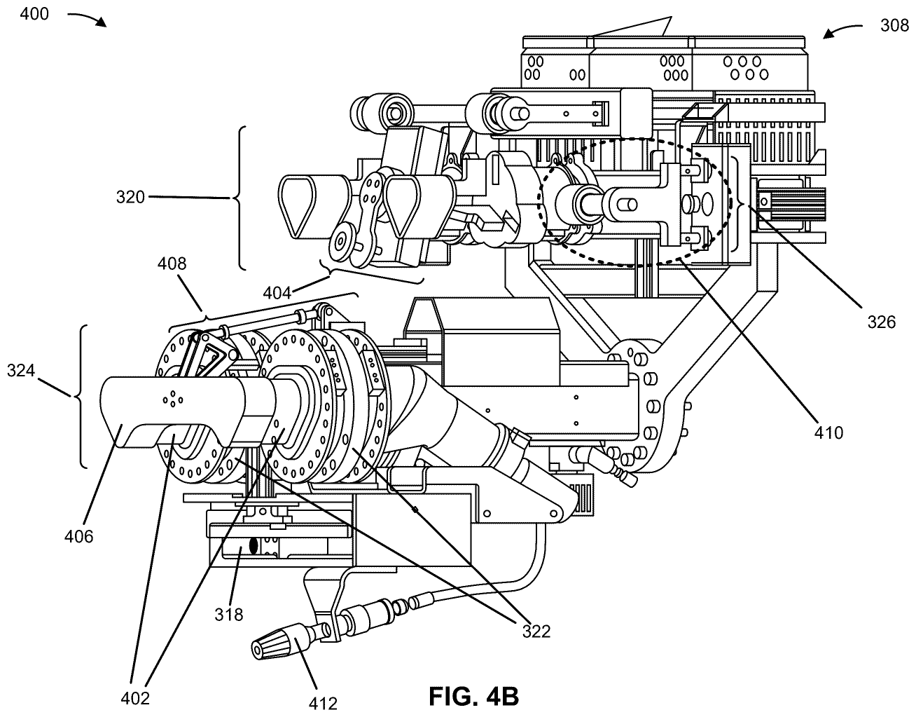

Accordingly, the robotic system includes the end effector 308, which may include (e.g., mounted to the end effector 308) the second camera system 318, the door opening system 320, the connector retention system 322, the connector protection system 324, and/or the door closing system 326. As the illustration of the end effector 308 is too small in FIGS. 3A-3B to clearly depict the second camera system 318, the door opening system 320, the connector retention system 322, the connector protection system 324, and/or the door closing system 326, these systems and the end effector 308 are shown in greater detail in FIGS. 4A-4B.

The second camera system 318 is configured to obtain second image data associated with the access mechanism 204 of the receptacle access point 104. For example, the second camera system 318 may obtain the second image data to allow the one or more controllers 328 to identify a location of the access mechanism 204 of the receptacle access point 104, such as to allow the door opening system 320 to open the access door 202 of the receptacle access point 104 (e.g., as further described herein). Further, the second camera system 318 is configured to obtain third image data associated with the one or more receptacles 206 included in the receptacle access point 104. For example, the second camera system 318 may obtain the third image data to allow the one or more controllers 328 to identify a location of the one or more receptacles 206, such as to enable one or more plugs of the end effector 308 (e.g., the one or more plugs 402 of the end effector 308 further described herein) to couple to the one or more receptacles 206 (e.g., as further described herein) and thereby enable the energy transfer operation.

The door opening system 320 is configured to open the access door 202 of the receptacle access point 104 (e.g., based on the location of the access mechanism 204 of the receptacle access point 104 identified by the one or more controllers 328). The door opening system 320 may include a manipulation system (e.g., the manipulation system 404 described herein in relation to FIGS. 4A-4B) for manipulating the access mechanism 204 of the receptacle access point 104 to allow the access door 202 to open.

The connector retention system 322 is configured to enable coupling between the one or more plugs of the end effector 308 (e.g., the one or more plugs 402 of the end effector 308 further described herein) and the one or more receptacles 206 (e.g., to enable the energy transfer operation). The connector retention system 322 may include a compliance system for facilitating coupling of the one or more plugs with the one or more receptacles 206.

The connector protection system 324 is configured to protect the one or more plugs of the end effector 308 (e.g., the one or more plugs 402 of the end effector 308 further described herein) when not coupled to the one or more receptacles 206. The connector protection system 324 may include a cap (e.g., the cap 406 described herein in relation to FIGS. 4A-4B) for covering the one or more plugs and a cap adjustment system (e.g., the cap adjustment system 408 described herein in relation to FIGS. 4A-4B) for removing the cap (e.g., from the one or more plugs) and for re-placing the cap (e.g., on the one or more plugs).

The door closing system 326 is configured to close the access door 202 of the receptacle access point 104 (e.g., after cessation of an energy transfer operation enabled by coupling of the one or more receptacles 206 with one or more plugs of the end effector 308). The door closing system 326 may include an interaction system (e.g., the interaction system 410 described herein in relation to FIGS. 4A-4B) for interacting with the access door 202 to allow the access door 202 to close.

As indicated above, FIGS. 3A-3B are provided as an example. Other examples may differ from what is described in connection with FIGS. 3A-3B.

FIGS. 4A-4B are diagrams of examples 400 of the end effector 308 of the robotic system 306 described herein. FIG. 4A shows a side-angled view of the end effector 308, and FIG. 4B shows a front-angled view of the end effector 308.

As shown in FIGS. 4A-4B, the end effector 308 includes one or more plugs 402. Each of the one or more plugs 402 may be any type of physical component for coupling with a corresponding receptacle 206 of the receptacle access point 104 to enable an energy transfer from the autonomous energy transfer system 300 to the work machine 100 (e.g., to the energy storage system 102 of the work machine 100) (or vice versa). While the term “plugs” are used herein, the one or more plugs 402 may include receptacles, ports, connectors, or any other type of physical energy transfer component.

As further shown in FIGS. 4A-4B, the end effector 308 may include (e.g., mounted to the end effector 308) the second camera system 318, the door opening system 320, the connector retention system 322, the connector protection system 324, and/or the door closing system 326. For example, as shown in FIGS. 4A-4B, the second camera system 318 may be positioned at a bottom of the end effector 308, the one or more plugs 402 may be positioned above the second camera system 318 (and the connector retention system 322 and the connector protection system 324 may be positioned in line with the one or more plugs 402), the door opening system 320 may be positioned above the one or more plugs 402, and the door opening system 320 may be positioned above the door closing system 326. While FIGS. 4A-4B show one possible configuration, some other configurations include the second camera system 318, the door opening system 320, the connector retention system 322, the connector protection system 324, and/or the door closing system 326 in different positions.

As shown in FIGS. 4A-4B, the door opening system 320 may include a manipulation system 404 for manipulating the access mechanism 204 of the receptacle access point 104 to allow the access door 202 of the receptacle access point 104 to open (e.g., when the receptacle access point 104 is within an engagement range of the robotic system 306). The manipulation system 404 may be configured to contact the access mechanism 204 of the receptacle access point 104 (e.g., when the access door 202 is in a closed position), to disengage the access mechanism 204 (e.g., by rotating the access mechanism 204), and to apply a force (e.g., a pulling force) on the access mechanism 204 to allow the access door 202 to open.

The connector protection system 324 may include a cap 406 for covering the one or more plugs 402 when the one or more plugs 402 are not coupled to the one or more receptacles 206 of the receptacle access point 104 (e.g., when an energy transfer operation is not occurring). Additionally, the connector protection system 324 may include a cap adjustment system 408 for removing the cap 406 when the one or more plugs 402 are to couple to the one or more receptacles 206 and for re-placing the cap 406 when the one or more plugs 402 are to uncouple from the one or more receptacles 206.

The door closing system 326 may include an interaction system 410 for interacting with the access door 202 to allow the access door 202 to close (e.g., when the receptacle access point 104 is within an engagement range of the robotic system 306). The interaction system 410 may be configured to contact the access door 202 (e.g., when the access door 202 is in an open position) and to apply a force (e.g., a pushing force) on the access door 202 to allow the access door 202 to close. The applied force may be greater than or equal to a force threshold associated with closing the access door 202 such that the access door is able to move to the closed position (e.g., by overcoming a resistive force of the one or more support components 212). The access door 202 then be locked in the closed position upon engagement of the access mechanism 204 of the receptacle access point 104.

As further shown in FIGS. 4A-4B, the end effector 308 may include one or more water nozzles 412 and/or one or more air nozzles 414. The one or more water nozzles 412 are configured to provide one or more streams of water to clean an exterior of the receptacle access point 104, such as to clean the access door 202 of the receptacle access point 104 (e.g., prior to the door opening system 320 opening the access door 202). Each stream of water may be pressurized (e.g., by pressure washer system 336) to increase a pressure of the water stream and therefore a corresponding cleaning capability of the water stream. In some implementations, the stream of water may include cold water (e.g., non-heated water), hot water (e.g., heated by a heater associated with the pressure washer system 336), steam (e.g., generated by the pressure washer system 336), or a detergent (e.g., a soap or another type of cleaning agent), among other examples. The one or more air nozzles 414 are configured to provide one or more streams of air to clean the interior panel 208 of the receptacle access point 104, such as the one or more receptacles 206 (e.g., prior to coupling with the one or more plugs 402 of the end effector 308). Each stream of air may be pressurized to increase a pressure of the air stream and therefore a corresponding cleaning capability of the air stream.

As indicated above, FIGS. 4A-4B are provided as an example. Other examples may differ from what is described in connection with FIGS. 4A-4B.

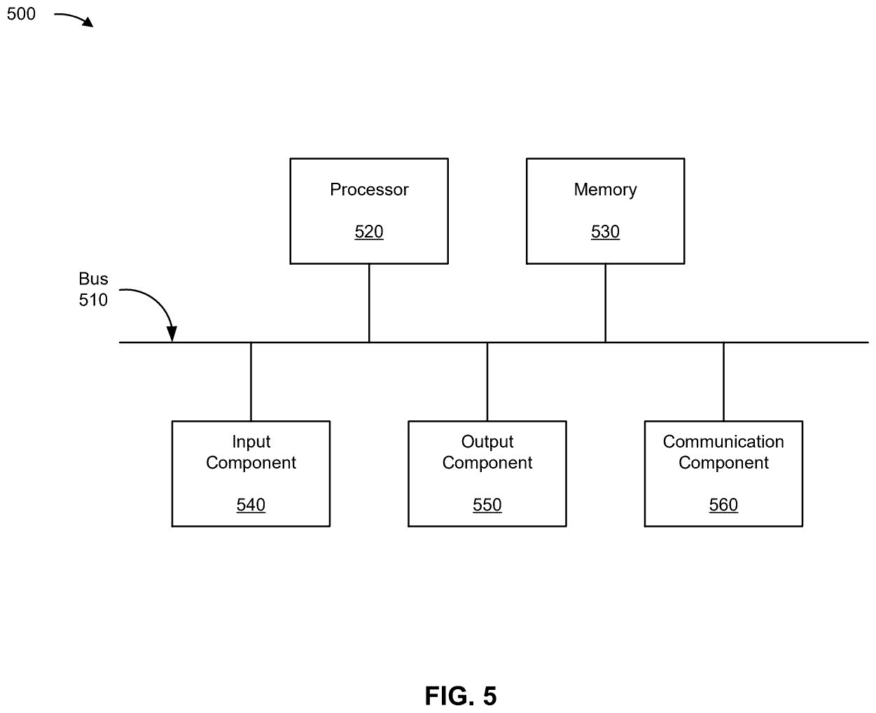

FIG. 5 is a diagram of example components of a device 500 associated with an autonomous energy transfer system 300. The device 500 may correspond to the one or more controllers 328 and/or one or more other components of the autonomous energy transfer system 300. The one or more controllers 328 and/or one or more other components of the autonomous energy transfer system 300 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. The processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. The memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. Execution of the set of instructions, by one or more processors 520, causes the one or more processors 520 and/or the device 500 to perform one or more operations or processes described herein. Hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

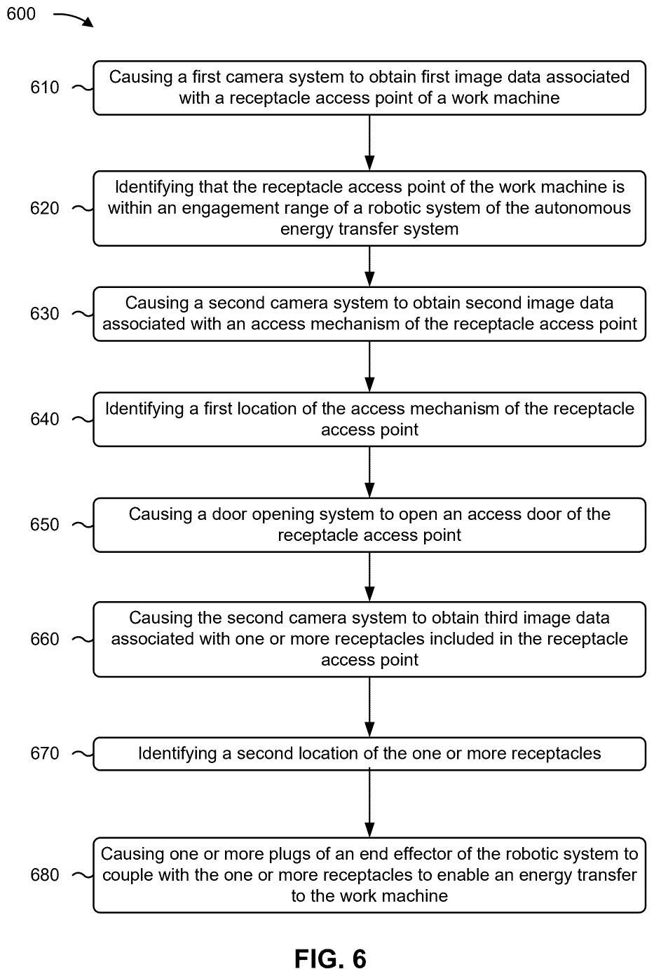

FIG. 6 is a flowchart of an example process 600 associated with an autonomous energy transfer system. One or more process blocks of FIG. 6 may be performed by one or more controllers (e.g., the one or more controllers 328) of an autonomous energy transfer system (e.g., the autonomous energy transfer system 300). One or more process blocks of FIG. 6 may be performed by another device or a group of devices separate from or including the one or more controllers, such as one or more other components of the autonomous energy transfer system. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include causing a first camera system to obtain first image data associated with a receptacle access point of a work machine (block 610). For example, the one or more controllers may cause a first camera system (e.g., the first camera system 316) to obtain first image data associated with a receptacle access point (e.g., the receptacle access point 104) of a work machine (e.g., the work machine 100).

As further shown in FIG. 6, process 600 may include identifying that the receptacle access point of the work machine is within an engagement range of a robotic system of the autonomous energy transfer system (block 620). For example, the one or more controllers may identify, based on the first image data, that the receptacle access point of the work machine is within an engagement range of a robotic system (e.g., the robotic system 306) of the autonomous energy transfer system.

As further shown in FIG. 6, process 600 may include causing a second camera system to obtain second image data associated with an access mechanism of the receptacle access point (block 630). For example, the one or more controllers may cause a second camera system (e.g., the second camera system 318) to obtain second image data associated with an access mechanism (e.g., the access mechanism 204) of the receptacle access point.

As further shown in FIG. 6, process 600 may include identifying a first location of the access mechanism of the receptacle access point (block 640). For example, the one or more controllers may identify, based on the second image data, a first location of the access mechanism of the receptacle access point.

As further shown in FIG. 6, process 600 may include causing a door opening system to open an access door of the receptacle access point (block 650). For example, the one or more controllers may cause, based on identifying the first location, a door opening system (e.g., the door opening system 320) to open an access door (e.g., the access door 202) of the receptacle access point.

As further shown in FIG. 6, process 600 may include causing the second camera system to obtain third image data associated with one or more receptacles included in the receptacle access point (block 660). For example, the one or more controllers may cause the second camera system to obtain third image data associated with one or more receptacles (e.g., the one or more receptacles 206) included in the receptacle access point.

As further shown in FIG. 6, process 600 may include identifying a second location of the one or more receptacles (block 670). For example, the one or more controllers may identify, based on the third image data, a second location of the one or more receptacles.

As further shown in FIG. 6, process 600 may include causing one or more plugs of an end effector of the robotic system to couple to the one or more receptacles to enable an energy transfer to the work machine (block 680). For example, the one or more controllers may cause, based on identifying the second location, one or more plugs (e.g., the one or more plugs 402) of an end effector (e.g., the end effector 308) of the robotic system to couple to the one or more receptacles to enable an energy transfer to (or from) the work machine. In some implementations, the one or more controllers may cause, before causing the one or more plugs to couple to the one or more receptacles, a connector protection system (e.g., the connector protection system 324) to remove a cap (e.g., the cap 406) from the one or more plugs.

In some implementations, the one or more controllers may cause, before causing the second camera system to obtain the second image data, a slide system (e.g., the slide system 310) to move, via a portal (e.g., the portal 304) at end of a housing (e.g., the housing 302), the robotic system from an interior of the housing to an external environment.

Process 600 may further include causing cessation of the energy transfer; causing, based on causing the cessation of the particular energy transfer, the connector protection system to re-place the cap on the one or more plugs; and causing, based on causing the cessation of the energy transfer, a door closing system (e.g., the door closing system 326) to close the access door of the receptacle access point.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

### INDUSTRIAL APPLICABILITY

The disclosed autonomous energy transfer system may be used to enable an energy transfer to and/or from a receptacle access point of a work machine (e.g., without any interaction with a human technician). Because the autonomous energy transfer system does not require interaction with a human technician, a safety of a work site (e.g., that is associated with an industry, such as mining, construction, farming, or transportation) is enhanced (e.g., by removing a need for the human technician, a risk of accident or injury to any human associated with enabling an energy transfer is reduced or eliminated).

For example, the work machine can move (or be moved) to a location proximate to the autonomous energy transfer system at the work site. The autonomous energy transfer system (using one or more controllers and a first camera system) detects that the receptacle access point of the work machine is within an engagement range of a robotic system of the autonomous energy transfer system. The autonomous energy transfer system (using the one or more controllers and a slide system) causes the robotic system to move from an interior of a housing of autonomous energy transfer system to the external environment. The autonomous energy transfer system (using the one or more controllers and one or more water nozzles of an end effector of the robotic system) cleans an access door of the receptacle access point, identifies and causes (using the one or more controllers, and a second camera system and a door opening system of the end effector) the access door to be opened. The autonomous energy transfer system (using the one or more controllers and a connector protection system of the end effector) causes a cap to be removed from one or more plugs of the end effector, and identifies and causes (using the one or more controllers and the second camera) the one or more plugs to couple to one or more receptacles of the receptacle access point to enable an energy transfer to (or from) the work machine. Further, the autonomous energy transfer system (using the one or more controllers and the connector protection system) causes cessation of the energy transfer and the cap to be re-placed on the one or more plugs (e.g., to protect the one or more plugs). The autonomous energy transfer system (using the one or more controllers and a connector protection system of the end effector) then causes the access door to be closed.

In this way, the autonomous energy transfer system enables an energy transfer to (or from) the work machine (e.g., to or from an energy storage system of the work machine). An energy transfer to the energy storage system of the work machine may cause the energy storage system to be replenished. Further, because the autonomous energy transfer system uses multiple camera systems and precision controlled systems, the autonomous energy transfer system facilitates an accurate coupling of the one or more plugs of the end effector and the one or more receptacles of the receptacle access point. This increase a likelihood of an optimal replenishment of the energy storage system of the work machine, such as in terms of decreasing an amount of time needed to replenish the energy storage system and in terms of enabling an increased replenishment level of the energy storage system (e.g., at, or near, a maximum replenishment level of the energy storage system). Optimal replenishment improves a performance of the work machine, such as by increasing an amount of time that the work machine is available to perform powered operations (e.g., as compared to an amount of time that the work machine needs to be replenished) and by increasing an amount of power that is available to perform the powered operations. Optimal replenishment of the electric machine also prevents, or minimizes a likelihood of, degradation of the energy storage system of the work machine, which improves a performance and/or operable life of the energy storage system, and the work machine.

Further, because the autonomous energy transfer system is able to extend the robotic system when a work machine is ready for an energy transfer, and to retract the robotic system after cessation of the energy transfer, systems and components of the end effector of the robotic system are not continuously subject to harsh environmental conditions of a work site. This can minimize an amount of wear-and-tear on the systems and components of the end effector, which improves a performance and/or operable life of the systems and components of the end effector, as well as the autonomous energy transfer system.

What is claimed is:

1. An autonomous energy transfer system, comprising:
a robotic system that includes an end effector;
a housing that includes a portal at an end of the housing;
a slide system for moving the robotic system, via the portal of the housing, between an interior of the housing and an external environment;
a cable management system mounted within the interior of the housing for providing management of energy transfer cables;
an energy transfer outlet system mounted within the interior of the housing for enabling connection between the energy transfer cables and an external energy transfer dispenser system;
a first camera system mounted on an exterior of the housing for obtaining first image data associated with a receptacle access point of a work machine;
a second camera system mounted on the end effector of the robotic system for obtaining second image data associated with an access mechanism of the receptacle access point and third image data associated with one or more receptacles included in the receptacle access point;
a door opening system mounted on the end effector of the robotic system for opening an access door of the receptacle access point;
a door closing system mounted on the end effector of the robotic system for closing the access door of the receptacle access point;
a connector retention system mounted on the end effector of the robotic system for enabling coupling between one or more plugs of the end effector and the one or more receptacles; and
a connector protection system mounted on the end effector of the robotic system for protecting the one or more plugs when the one or more plugs are not coupled to the one or more receptacles.

2. The autonomous energy transfer system of claim 1, wherein:
the slide system includes a mount for connecting to the robotic system; and
the slide system includes a slide apparatus for moving the robotic system and providing management of cables associated with operation of the robotic system.

3. The autonomous energy transfer system of claim 1, wherein:
the cable management system includes a cable holder component for prevention of bending of the energy transfer cables beyond a bend radius of the energy transfer cables; and
the cable management system includes a slide apparatus for moving the cable holder component in association with movement of the robotic system by the slide system.

4. The autonomous energy transfer system of claim 1, wherein:
the slide system is positioned within a region of the interior of the housing that is associated with the end of the housing; and
the energy transfer outlet system is also positioned within the region of the interior of the housing.

5. The autonomous energy transfer system of claim 1, wherein:
the door opening system includes a manipulation system for contacting the access mechanism of the receptacle access point when the access door is in a closed position, for disengaging the access mechanism, and for applying a force on the access mechanism to allow the access door to open.

6. The autonomous energy transfer system of claim 1, wherein:
the door closing system includes an interaction system for contacting the access door when the access door is in an open position and for applying a force on the access door to allow the access door to close.

7. The autonomous energy transfer system of claim 1, wherein:
the connector retention system includes a compliance system for facilitating coupling of the one or more plugs with the one or more receptacles to enable energy transfer to the work machine.

8. The autonomous energy transfer system of claim 1, wherein:
the connector protection system includes a cap for covering the one or more plugs when the one or more plugs are not coupled to the one or more receptacles; and
the connector protection system includes a cap adjustment system for removing the cap when the one or more plugs are to couple to the one or more receptacles and for re-placing the cap when the one or more plugs are to uncouple from the one or more receptacles.

9. The autonomous energy transfer system of claim 1, further comprising one or more controllers configured to:
cause the first camera system to obtain the first image data;
identify, based on the first image data, that the receptacle access point of the work machine is within an engagement range of the robotic system;
cause, based on identifying that the receptacle access point of the work machine is within the engagement range of the robotic system, the slide system to move the robotic system from the interior of the housing to the external environment;
cause, based on causing the slide system to move the robotic system, the second camera system to obtain the second image data;
identify, based on the second image data, a first location of the access mechanism of the receptacle access point;
cause, based on identifying the first location, the door opening system to open the access door of the receptacle access point;
cause, based on causing the door opening system to open the access door, the second camera system to obtain the third image data;
identify, based on the third image data, a second location of the one or more receptacles;
cause, based on identifying the second location, the connector protection system to remove a cap from the one or more plugs; and
cause, based on removing the cap, the one or more plugs to couple to the one or more receptacles to enable a particular energy transfer to the work machine.

10. The autonomous energy transfer system of claim 9, wherein the one or more controllers are further configured to:
cause, when the one or more plugs are coupled to the one or more receptacles, cessation of the particular energy transfer;
cause, based on causing the cessation of the particular energy transfer, the connector protection system to re-place the cap on the one or more plugs; and
cause, based on causing the cessation of the particular energy transfer, the door closing system to close the access door of the receptacle access point.

11. An end effector of a robotic system, comprising:
a camera system for obtaining first image data associated with an access mechanism of a receptacle access point of a work machine and second image data associated with one or more receptacles included in the receptacle access point;
a door opening system for opening an access door of the receptacle access point;
a door closing system for closing the access door of the receptacle access point;
a connector retention system for enabling coupling between one or more plugs of the end effector and the one or more receptacles; and
a connector protection system for protecting the one or more plugs when the one or more plugs are not coupled to the one or more receptacles.

12. The end effector of the robotic system of claim 11, wherein:
the door opening system includes a manipulation system for manipulating the access mechanism of the receptacle access point to allow the access door to open.

13. The end effector of the robotic system of claim 11, wherein:
the door closing system includes an interaction system for interacting with the access door to allow the access door to close.

14. The end effector of the robotic system of claim 11, wherein:
the connector retention system includes a compliance system for facilitating coupling of the one or more plugs with the one or more receptacles.

15. The end effector of the robotic system of claim 11, wherein:
the connector protection system includes a cap for covering the one or more plugs; and
the connector protection system includes a cap adjustment system for removing and re-placing the cap.

16. A method, comprising:
causing, by a controller of an autonomous energy transfer system, a first camera system to obtain first image data associated with a receptacle access point of a work machine;
identifying, by the controller and based on the first image data, that the receptacle access point of the work machine is within an engagement range of a robotic system of the autonomous energy transfer system;
causing, by the controller, a second camera system to obtain second image data associated with an access mechanism of the receptacle access point;
identifying, by the controller and based on the second image data, a first location of the access mechanism of the receptacle access point;
causing, by the controller and based on identifying the first location, a door opening system to open an access door of the receptacle access point;
causing, by controller, the second camera system to obtain third image data associated with one or more receptacles included in the receptacle access point;
identifying, by the controller and based on the third image data, a second location of the one or more receptacles; and
causing, by the controller and based on identifying the second location, one or more plugs of an end effector of the robotic system to couple to the one or more receptacles to enable an energy transfer to the work machine.

17. The method of claim 16, further comprising.
causing, before causing the second camera system to obtain the second image data, a slide system to move, via a portal at end of a housing, the robotic system from an interior of the housing to an external environment.

18. The method of claim 16, further comprising.
causing, before causing the one or more plugs to couple to the one or more receptacles, a connector protection system to remove a cap from the one or more plugs.

19. The method of claim 16, further comprising:
causing cessation of the energy transfer; and
cause, based on causing the cessation of the energy transfer, a door closing system to close the access door of the receptacle access point.

20. The method of claim 16, wherein:
the first camera system is mounted on an exterior of a housing for the robotic system; and
the second camera system and the door opening system are mounted on the end effector of the robotic system.
